(19) United States
(12) Patent Application Publication
(10) Pub. No.: US 2024/0302726 A1
(43) Pub. Date: Sep. 12, 2024

(54) PROJECTION APPARATUS AND OVERHEATING PROTECTION METHOD THEREOF

(71) Applicant: Qisda Corporation, Taoyuan City (TW)

(72) Inventors: Chia-Chun Hsu, Taoyuan City (TW); Chih-Wei Cho, Taoyuan City (TW)

(73) Assignee: Qisda Corporation, Taoyuan City (TW)

(21) Appl. No.: 18/443,251

(22) Filed: Feb. 15, 2024

(30) Foreign Application Priority Data
Mar. 6, 2023 (CN) 202310203674.0

(51) Int. Cl. G03B 21/16; G01K 3/04; G01K 3/10

(52) U.S. Cl. CPC G03B 21/16; G01K 3/04; G01K 3/10

(57) ABSTRACT

A projection apparatus and an overheating protection method thereof are provided. An initial stable temperature corresponding to an initial accumulated usage time during an initial usage period is obtained by using a temperature sensor in the projection apparatus. At least one stable temperature respectively corresponding to at least one accumulated usage time is obtained by using the temperature sensor in the projection apparatus. An estimated time corresponding to a target temperature is estimated according to the initial accumulated usage time, the initial stable temperature, the at least one stable temperature, and the at least one accumulated usage time. A temperature protection operation of the projection apparatus is executed in response to a current accumulated usage time of the projection apparatus exceeding the estimated time.

### CROSS-REFERENCE TO RELATED APPLICATION

This application claims the priority benefit of China application serial no. 202310203674.0, filed on Mar. 6, 2023. The entirety of the above-mentioned patent application is hereby incorporated by reference herein and made a part of this specification.

### BACKGROUND

### Technical Field

The disclosure relates to a projection apparatus, and in particular to a projection apparatus and an overheating protection method thereof.

### Description of Related Art

With the development of projection technology, projectors have been widely used in homes, offices, schools, and other places. Regardless of the type of the projection technology, the light emitted by a light source generally passes through many optical elements. When the light passes through the optical elements, heat energy is accumulated in the optical elements. Once the temperature of the optical element exceeds an allowable value, the optical element may be irreversibly damaged, which permanently affects the viewing quality of the user. At present, most of the heat dissipation manners of the optical elements take away the heat energy using flowing air flow. In order to generate the air flow, the projectors generally have fans and vents on their housings. It is known that when the vents of the projectors are accumulated with dust or blocked, or the fans fail, the heat dissipation capacities of the projectors are greatly reduced, which may cause the temperatures of the optical elements to be too high and cause damage.

In order to prevent irreversible damage to the optical element due to heat accumulation, the most intuitive way is to directly monitor the temperature of the optical element. When the temperature of the optical element exceeds the allowable value, a subsequent overheating protection mechanism may be activated to protect the optical element. However, if the temperature of the optical element is to be directly monitored, a temperature sensing element needs to be disposed on the optical element, so a special airtight structure needs to be additionally designed to ensure the dustproof effect of an optical engine. Alternatively, in order not to destroy the airtight effect of the optical engine, multiple temperature sensing elements need to be arranged around the outside of the optical engine including the optical element, and the temperature of the optical element is inferred according to the sensed temperatures of the temperature sensing elements. However, the arrangement positions of the temperature sensing elements and the response time of heat conduction both affect whether the overheating protection mechanism is timely activated. Moreover, regardless of the special airtight structure or the arrangement of the temperature sensing elements, exclusive designs and calibration procedures need to be performed for the projectors with different structures.

### SUMMARY

Embodiments of the disclosure provide a projection apparatus and an overheating protection method thereof, which can prevent an optical element in the projection apparatus from being damaged due to overheating.

An embodiment of the disclosure provides an overheating protection method of a projection apparatus, which includes the following steps. An initial stable temperature corresponding to an initial accumulated usage time during an initial usage period is obtained by using a temperature sensor in the projection apparatus. At least one stable temperature respectively corresponding to at least one accumulated usage time is obtained by using the temperature sensor in the projection apparatus. An estimated time corresponding to a target temperature is estimated according to the initial accumulated usage time, the initial stable temperature, the at least one stable temperature, and the at least one accumulated usage time. A temperature protection operation of the projection apparatus is executed in response to a current accumulated usage time of the projection apparatus exceeding the estimated time.

The disclosure provides a projection apparatus, which includes a temperature sensor and a controller. The controller is coupled to the temperature sensor and is configured to execute the following operations. An initial stable temperature corresponding to an initial accumulated usage time during an initial usage period is obtained by using the temperature sensor. At least one stable temperature respectively corresponding to at least one accumulated usage time is obtained by using the temperature sensor. An estimated time corresponding to a target temperature is estimated according to the initial accumulated usage time, the initial stable temperature, the at least one stable temperature, and the at least one accumulated usage time. A temperature protection operation of the projection apparatus is executed in response to a current accumulated usage time of the projection apparatus exceeding the estimated time.

Based on the above, in the projection apparatus and the overheating protection method thereof according to the embodiments of the disclosure, the accumulated usage time and the stable temperature of the projection apparatus after being turned on are recorded to estimate the estimated time corresponding to the target temperature. When the current accumulated usage time of the projection apparatus exceeds the estimated time, it means that the heat dissipation capacity of the projection apparatus may not be able to meet the heat dissipation requirements, and the temperature protection operation of the projection apparatus may be timely executed. Therefore, before the optical element is damaged due to overheating, the temperature protection operation may be timely executed to effectively prevent the internal optical element from being damaged due to overheating of the projection apparatus.

In order for the features and advantages of the disclosure to be more comprehensible, the following specific embodiments are described in detail in conjunction with the drawings.

### BRIEF DESCRIPTION OF THE DRAWINGS

FIG. 1 is a schematic diagram of a projection apparatus according to an embodiment of the disclosure.

FIG. 2 is a flowchart of an overheating protection method according to an embodiment of the disclosure.

FIG. 3 is a flowchart of obtaining an initial stable temperature corresponding to an initial accumulated usage time during an initial usage period according to an embodiment of the disclosure.

FIG. 4 is a schematic diagram of multiple temperature rising curves according to an embodiment of the disclosure.

FIG. 5 is a schematic diagram of stable temperature against temperature stabilizing time according to an embodiment of the disclosure.

FIG. 6 is a schematic diagram of temperature stabilizing time against accumulated usage time according to an embodiment of the disclosure.

FIG. 7 is a schematic diagram of stable temperature against accumulated usage time according to an embodiment of the disclosure.

FIG. 8 is a flowchart of an overheating protection method according to an embodiment of the disclosure.

FIG. 9 is a schematic diagram of temperature rising curves of multiple turn-on processes according to an embodiment of the disclosure.

FIG. 10 is a schematic diagram of ratio against temperature stabilizing time according to an embodiment of the disclosure.

### DESCRIPTION OF THE EMBODIMENTS

In order for the content of the disclosure to be more comprehensible, the following specific embodiments are given as examples according to which the disclosure can indeed be implemented. The embodiments are only a part of the disclosure and do not disclose all possible implementations of the disclosure. Rather, the embodiments are only examples of methods and apparatuses within the scope of the disclosure. In addition, wherever possible, elements/components/steps using the same reference numerals in the drawings and the implementations represent the same or similar parts.

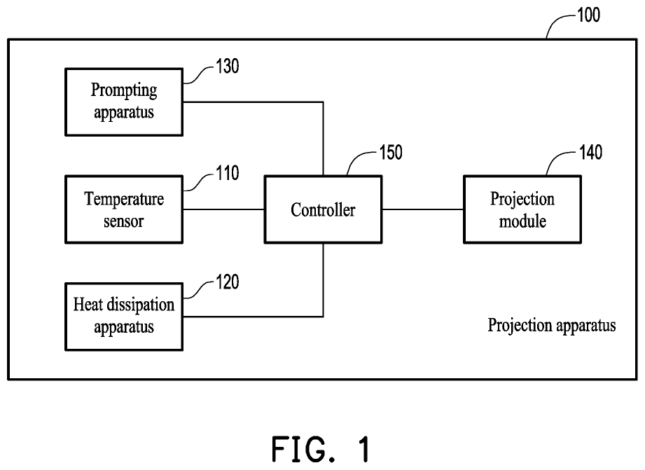

FIG. 1 is a schematic diagram of a projection apparatus according to an embodiment of the disclosure. Referring to FIG. 1, a projection apparatus 100 includes a temperature sensor 110, a heat dissipation apparatus 120, a prompting apparatus 130, a projection module 140, and a controller 150. The controller 150 is coupled to the temperature sensor 110, the heat dissipation apparatus 120, the prompting apparatus 130, and the projection module 140.

The temperature sensor 110 may be used to sense temperature. The temperature sensor 110 may be disposed inside the projection apparatus 100 to sense the temperature inside the projection apparatus 100. The position of the temperature sensor 110 may be determined according to design requirements. For example, in some embodiments, the temperature sensor 110 may be disposed around a vent of a housing of the projection apparatus 100. In other embodiments, the temperature sensor 110 may be disposed around the projection module 140 or disposed in the projection module 140. In other embodiments, the temperature sensor 110 may be disposed around the heat dissipation apparatus 120. In other embodiments, the temperature sensor 110 may be disposed around the controller 150.

The heat dissipation apparatus 120 may include a fan, a cooling chip, a water-cooling heat dissipation apparatus, other heat dissipation devices, or a combination of the apparatuses. The heat dissipation apparatus 120 provides a heat dissipation function, which may take away heat energy inside the projection apparatus 100.

The prompting apparatus 130 may include one or more output apparatuses, such as a speaker, a prompting light, or a display apparatus. In some embodiments, the prompting apparatus 130 may provide a warning message to the user to inform that the heat dissipation capacity of the projection apparatus 100 is abnormal.

The projection module 140 may include a projection light source, a projection optical engine, and an optical system. The projection light source may include a light emitting unit such as a discharge bulb, a light emitting diode, or a laser light source. The projection optical engine may include a reflective spatial light modulation device or a transmissive spatial light modulation device. The reflective spatial light modulation device may, for example, include a reflective liquid crystal on silicon (LCOS) or a digital micro-mirror device (DMD). The transmissive spatial light modulation device may, for example, include a transparent liquid crystal panel. The optical system may include multiple lenses, and the lenses may be disposed on an optical path of a projection beam.

In the embodiment, the controller 150 may include a central processing unit (CPU), other programmable general purpose or specific purpose microprocessors, digital signal processors (DSP), programmable controllers, application specific integrated circuits (ASIC), programmable logic devices (PLD), other similar control apparatuses, or a combination of the apparatuses.

In addition, in some embodiments, the projection apparatus 100 may also include a memory, wherein the memory may, for example, be a removable random access memory (RAM), a read-only memory (ROM), a flash memory, or similar elements, or a combination of the above elements. The memory may be used to store image data, commands, projection control programs, etc., for the controller 150 to access and execute.

In the embodiment of the disclosure, after the projection apparatus 100 is turned on, the controller 150 may record the temperature sensed by the temperature sensor 110, and analyze temperature record information to speculate the heat dissipation capacity and the heat dissipation situation of the projection apparatus 100. Based on this, when the heat dissipation capacity of the projection apparatus 100 is poor or an abnormal heat dissipation event occurs, the controller 150 may instantly and timely execute a temperature protection operation of the projection apparatus 100 to prevent damage to optical elements of the projection apparatus 100. Embodiments will be listed below for clear description.

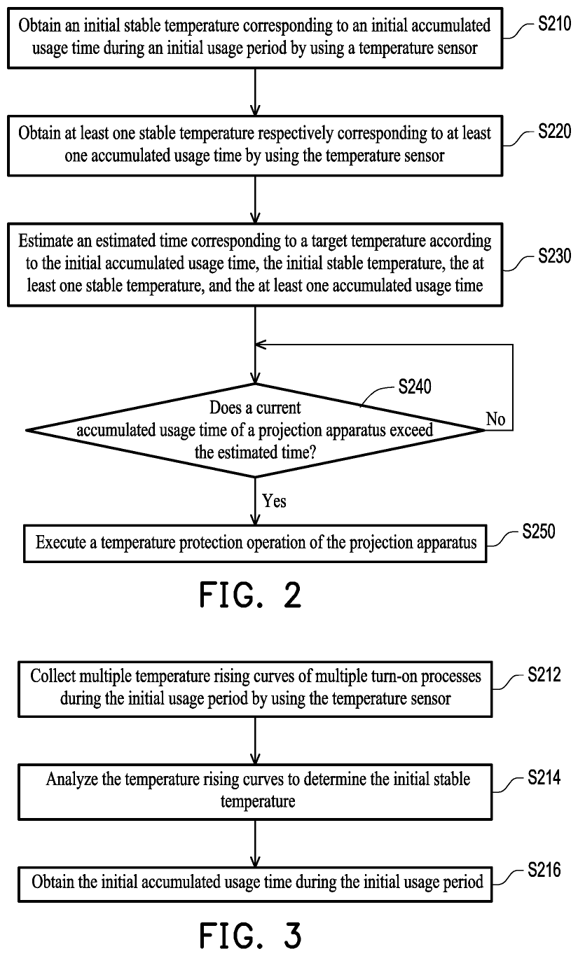

FIG. 2 is a flowchart of an overheating protection method according to an embodiment of the disclosure. Please refer to FIG. 1 and FIG. 2. The manner of the embodiment is applicable to the projection apparatus 100 in the foregoing embodiment, and the detailed steps of the overheating protection method of the embodiment will be described below with various elements in the projection apparatus 100.

In Step S210, the controller 150 obtains an initial stable temperature corresponding to an initial accumulated usage time during an initial usage period by using the temperature sensor 110 in the projection apparatus 100. Specifically, after the projection apparatus 100 is turned on every time, as heat energy generated by a light source of the projection module 110 gradually accumulates, the temperature inside the projection apparatus 100 gradually rises. Under the action of the heat dissipation apparatus 120, the temperature inside the projection apparatus 100 rises to a stable temperature.

In some embodiments, the controller 150 obtains a sensed temperature change through the temperature sensor 110 after the projection apparatus 100 is turned on every time to generate a temperature rising curve. The controller 150 may record the temperature rising curves of multiple turn-on processes during the initial usage period, and generate the initial stable temperature through analyzing the temperature rising curves during the initial usage period.

Herein, the initial usage period represents an early usage period when the projection apparatus 100 is activated by the user to execute a projection function after leaving the factory.

In more detail, FIG. 3 is a flowchart of obtaining an initial stable temperature corresponding to an initial accumulated usage time during an initial usage period according to an embodiment of the disclosure. Please refer to FIG. 3. In Step S212, the controller 150 collects multiple temperature rising curves of multiple turn-on processes during the initial usage period by using the temperature sensor 110. Specifically, after the projection apparatus 100 is turned on every time, the temperature sensor 110 may continuously perform temperature sensing, and the controller 150 may establish the temperature rising curve of each turn-on process according to multiple temperature sensing values provided by the temperature sensor 110 during the initial usage period.

In some embodiments, the controller 150 may collect the sensed temperatures of n turn-on processes (for example, the 1st turn-on process to the 20th turn-on process) to establish n temperature rising curves corresponding to the n turn-on processes. In other words, in some embodiments, the length of the initial usage period may depend on the number of times the projection apparatus 100 is turned on. Alternatively, in some embodiments, the length of the initial usage period may depend on the accumulated usage time of the projection apparatus 100.

It should be noted that the accumulated usage time of the projection apparatus 100 is the total running time of the projection apparatus 100. When the projection apparatus 100 is turned on, the accumulated usage time of the projection apparatus 100 continuously increases.

Moreover, whenever the projection apparatus 100 is turned on again, the accumulated usage time of the projection apparatus 100 continues to be accumulated based on the previous accumulated value.

In Step S214, the controller 150 analyzes the temperature rising curves to determine the initial stable temperature. In some embodiments, when the controller 150 judges that a sufficient number of temperature rising curves are collected, the controller 150 may start to analyze the temperature rising curves to determine the initial stable temperature. For example, when the projection apparatus 100 is turned on 20 times, the controller 150 may start to analyze 20 temperature rising curves to determine the initial stable temperature. Alternatively, in some other embodiments, when the controller 150 judges that the accumulated usage time of the projection apparatus 100 is greater than or equal to a preset value, the controller 150 may start to analyze the temperature rising curves to determine the initial stable temperature. For example, when the accumulated usage time of the projection apparatus 100 increases to equal to 20 hours, the controller 150 may start to analyze the n temperature rising curves to determine the initial stable temperature.

In some embodiments, the controller 150 may obtain a reference stable temperature of each temperature rising curve. It can be known that each temperature rising curve corresponds to one reference stable temperature. Next, the controller 150 performs statistical analysis on the reference stable temperature of each temperature rising curve to determine the initial stable temperature. In other words, the initial stable temperature may, for example, be the mean, mode, median, or other statistical value generated by the statistical analysis of the reference stable temperatures.

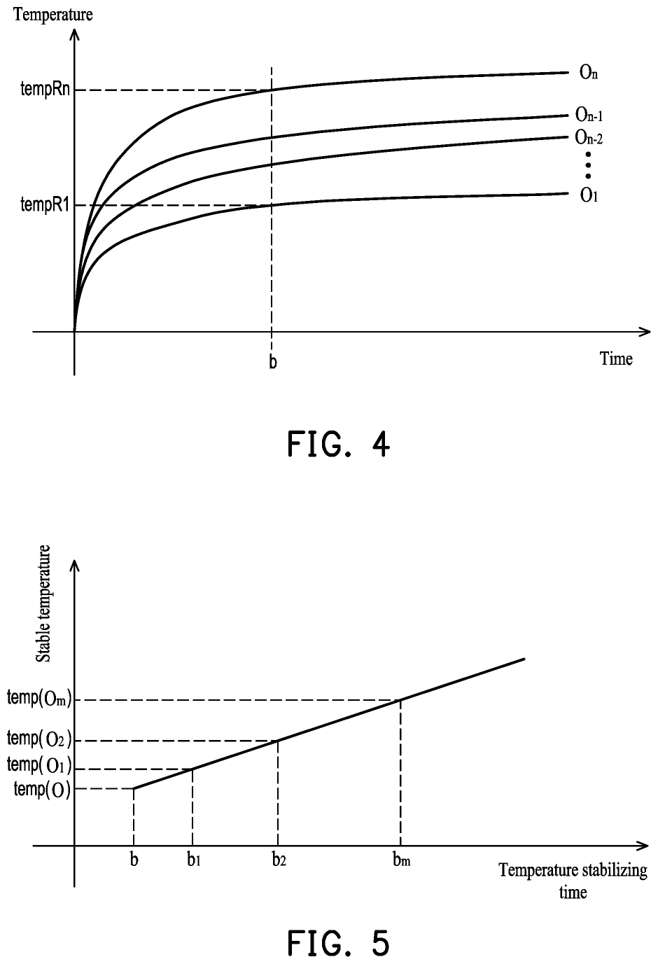

Please refer to FIG. 4, which is a schematic diagram of multiple temperature rising curves according to an embodiment of the disclosure. The controller 150 may obtain n temperature rising curves O₁ to Oₙ during the initial usage period by using the temperature sensor 110. The temperature rising curves O₁ to Oₙ are temperature change data sensed by the temperature sensor 110 after the projection apparatus 100 is turned on during the initial usage period. Each of the temperature rising curves O₁ to Oₙ corresponds to one reference stable temperature. For example, the temperature rising curve O₁ corresponds to a reference stable temperature tempR1, and the temperature rising curve Oₙ corresponds to a reference stable temperature tempRn. The controller 150 may determine the initial stable temperature according to the reference stable temperatures corresponding to the temperature rising curves O₁ to Oₙ. Generally speaking, during the initial usage period, the heat dissipation capacity of the projection apparatus 100 is preferable. Therefore, during the initial usage period, the differences between the reference stable temperatures corresponding to the temperature rising curves O₁ to Oₙ are relatively small, and temperature stabilizing times corresponding to the reference stable temperatures on the temperature rising curves O₁ to Oₙ are similar to each other. In the embodiment, the stabilizing times taken by the temperature rising curves O₁ to Oₙ to reach the reference stable temperatures may be the same temperature stabilizing time b due to being similar to each other. In other words, based on the temperature rising curves O₁ to Oₙ of FIG. 4, the controller 150 may determine the initial stable temperature and the corresponding temperature stabilizing time b.

Afterwards, in Step S216, the controller 150 may obtain the initial accumulated usage time during the initial usage period in response to determining the initial stable temperature. Specifically, after the projection apparatus 100 is turned on for n times during the initial usage period, the controller 150 may determine the initial stable temperature and accumulate the running time of the n running processes to obtain the initial accumulated usage time. Taking FIG. 4 as an example, after the number of times the projection apparatus 100 is turned on increases from 0 to 20, the controller 150 may determine the initial stable temperature and accumulate the running time of the 20 running processes to obtain the initial accumulated usage time. Therefore, the controller 150 may obtain the initial stable temperature corresponding to the initial accumulated usage time.

Referring back to FIG. 2, after obtaining the initial stable temperature corresponding to the initial accumulated usage time, the controller 150 has obtained an initial value for estimating an estimated time corresponding to a target temperature. After that, in Step S220, the controller 150 obtains at least one stable temperature respectively corresponding to at least one accumulated usage time by using the temperature sensor 110 in the projection apparatus 100. Specifically, after the initial usage period, the controller 150 may still obtain the sensed temperature change through the temperature sensor 110 after the projection apparatus 100 is turned on every time to obtain a stable temperature after the projection apparatus 100 is turned on every time. Moreover, the controller 150 also continuously accumulates the accumulated usage time of the projection apparatus 100, and obtains the accumulated usage time corresponding to the projection apparatus 100 reaching the stable temperature after being turned on every time. As the number of times of being turned on increases, the controller 150 may obtain more and more stable temperatures and the corresponding accumulated usage time.

In detail, please refer to FIG. 5, which is a schematic diagram of stable temperature against temperature stabilizing time according to an embodiment of the disclosure. After the initial usage period, the controller 150 may obtain multiple stable temperatures temp(Oᵢ) and temperature stabilizing times bᵢ corresponding to the stable temperatures temp(Oᵢ), where i represents the number of times of being turned on after the initial usage period. In the embodiment of FIG. 5, after the initial usage period, the projection apparatus 100 is turned on again for m times. Thus, the controller 150 may obtain m stable temperatures temp(O₁), temp(O₂), . . . , temp(Oₘ) and temperature stabilizing times b₁, b₂, . . . , bₘ corresponding to the m stable temperatures temp(O₁), temp(O₂), . . . , temp(Oₘ). It should be noted that as the projection apparatus 100 is continuously used, due to dust accumulation, aging of a fan apparatus, or other factors, the heat dissipation capacity of the projection apparatus 100 gradually decreases. Therefore, as the projection apparatus 100 is continuously used, the stable temperatures temp(O₁), temp(O₂), . . . , temp(Oₘ) of the projection apparatus 100 rise as the number of times the projection apparatus 100 is used increases, and the temperature stabilizing times b₁, b₂, . . . , bₘ for the projection apparatus 100 to reach the stable temperatures temp(O₁), temp(O₂), . . . , temp(Oₘ) also increase as the number of times the projection apparatus 100 is used increases. Here, an initial stable temperature temp(O) of the projection apparatus 100 may be generated according to multiple reference stable temperatures during the initial usage period shown in FIG. 4, and the initial stable temperature temp(O) may correspond to the temperature stabilizing time b shown in FIG. 4.

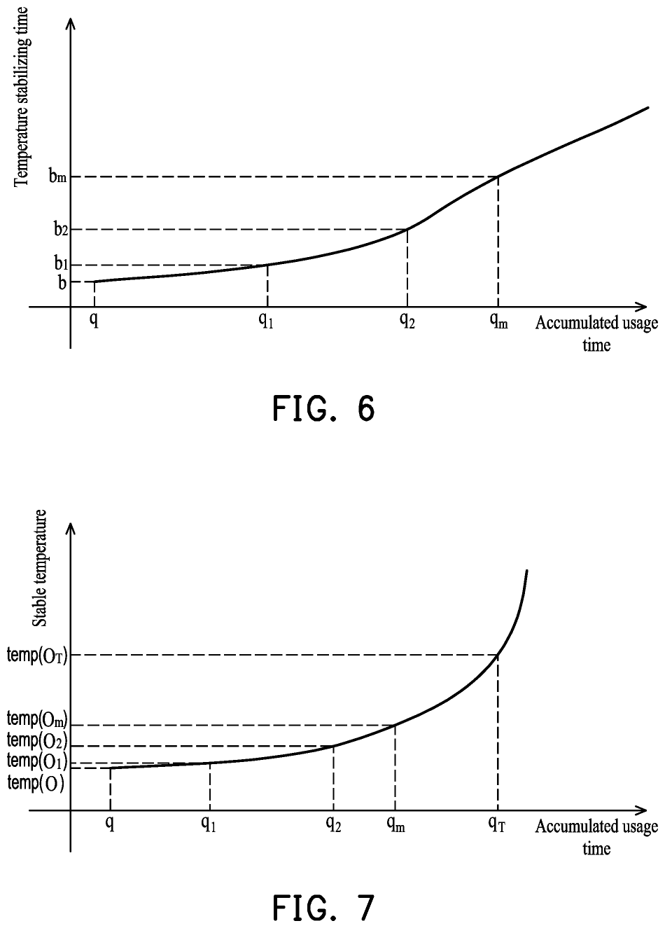

Continuing with the embodiment of FIG. 5, please refer to FIG. 6, which is a schematic diagram of temperature stabilizing time against accumulated usage time according to an embodiment of the disclosure. Through timing the time period when the projection apparatus 100 is turned on, the controller 150 may obtain the accumulated usage time corresponding to each of the temperature stabilizing times b₁, b₂, . . . , bₘ. The temperature stabilizing time b of the initial stable temperature temp(O) corresponds to an initial accumulated usage time q. The temperature stabilizing time b₁ of the stable temperature temp(O₁) corresponds to an accumulated usage time q₁. The temperature stabilizing time b2 of the stable temperature temp(O₂) corresponds to an accumulated usage time q₂. Similarly, the temperature stabilizing time bₘ of the stable temperature temp(Oₘ) corresponds to an accumulated usage time qₘ.

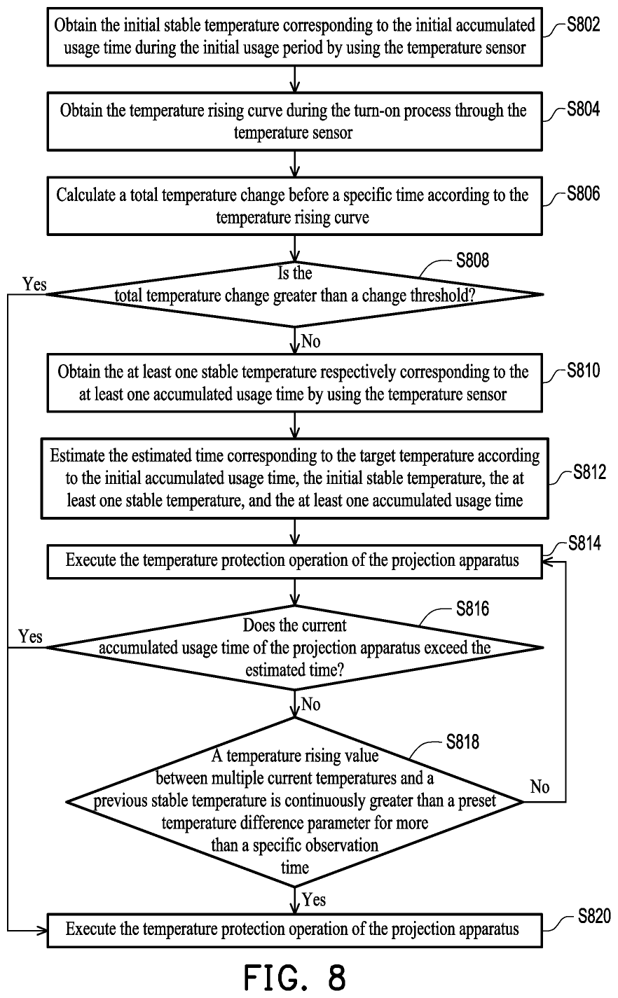

Continuing with the embodiments of FIG. 5 and FIG. 6, please refer to FIG. 7, which is a schematic diagram of stable temperature against accumulated usage time according to an embodiment of the disclosure. After the controller 150 obtains a corresponding relationship between the stable temperatures temp(O₁), temp(O₂), . . . , temp(Oₘ) and the temperature stabilizing times b₁, b₂, . . . , bₘ (as shown in FIG. 5) and a corresponding relationship between the temperature stabilizing times b₁, b₂, . . . , bₘ and the accumulated usage times q₁, q₂, . . . , qₘ (as shown in FIG. 6), the controller 150 may obtain a corresponding relationship between the stable temperatures temp(O₁), temp(O₂), . . . , temp(Oₘ) and the accumulated usage times q₁, q₂, . . . , qₘ (as shown in FIG. 7).

In the embodiment of FIG. 7, the initial stable temperature temp(O) corresponds to the initial accumulated usage time q of the projection apparatus 100. The stable temperature temp(O₁) corresponds to the accumulated usage time q₁ of the projection apparatus 100. The stable temperature temp(O₂) corresponds to the accumulated usage time q₂ of the projection apparatus 100. Similarly, the stable temperature temp(Oₘ) corresponds to the accumulated usage time qₘ of the projection apparatus 100.

Then, in Step S230, the controller 150 estimates the estimated time corresponding to the target temperature according to the initial accumulated usage time, the initial stable temperature, the at least one stable temperature, and the at least one accumulated usage time. Specifically, when the poor heat dissipation capacity of the projection apparatus 100 causes the stable temperature of the projection apparatus 100 to approach the target temperature, it means that the optical elements of the projection apparatus 100 may have been damaged. The target temperature may be determined according to actual requirements and experimental results.

In some embodiments, the controller 150 may establish an interpolation polynomial by using the initial accumulated usage time, the initial stable temperature, the at least one stable temperature, and the at least one accumulated usage time. The interpolation polynomial is, for example, a Lagrange polynomial or a Newton polynomial. Then, the controller 150 may substitute the target temperature into the interpolation polynomial to obtain the estimated time.

In detail, please continue to refer to the embodiment of FIG. 7. After obtaining multiple two-dimensional coordinate points (temp(O), q), (temp(O₁), q₁), (temp(O₂), q₂), . . . , (temp (Oₘ), qₘ), the controller 150 may calculate a curve equation passing through the two-dimensional coordinate points, and the curve equation may be a polynomial equation. The polynomial equation may be used as a predictive formula for the stable temperature change and the accumulated usage time of the projection apparatus 100. The controller 150 may substitute a target temperature temp(O_{T}) into the polynomial to obtain a corresponding estimated time qr. For example, in the embodiment of FIG. 7, the estimated time q_{T} may be expressed by Formula (1) below.

$${q}_{T} = {\sum }_{j = 0}^{m} {q}_{j} {\prod }_{{0 \leq k \leq m}_{k \neq j}} \frac{temp ( {o}_{T} ) - temp ( {o}_{k} )}{temp ( {o}_{j} ) - temp ( {o}_{k} )} \qquad Formula ( 1 )$$

In other words, when the accumulated usage time of the projection apparatus 100 approaches the estimated time q_{T}, the temperature sensed by the temperature sensor 100 may reach the target temperature temp(O_{T}), and the optical elements may be damaged. Therefore, in Step S240, the controller 150 judges whether a current accumulated usage time of the projection apparatus 100 exceeds the estimated time. In other words, the controller 150 instantly judges whether the current accumulated usage time exceeds the estimated time.

If the judgement of Step S240 is yes, Step S250 is executed. In Step S250, the controller 150 executes a temperature protection operation of the projection apparatus 100 in response to the current accumulated usage time of the projection apparatus 100 exceeding the estimated time. In some embodiments, the temperature protection operation includes increasing the heat dissipation capacity of the heat dissipation apparatus 120 or providing a warning message through the prompting apparatus 130. For example, the temperature protection operation may include increasing the rotational speed of a fan or increasing the cooling capacity of a cooling apparatus. Alternatively, the temperature protection operation may include reducing the brightness of the light source of the projection module 140 or reducing the working frequency of the chip inside the projection apparatus 100. Alternatively, the temperature protection operation may include displaying the warning message on a projection screen in an on-screen display (OSD) manner. Alternatively, the temperature protection operation may include enabling a prompting light apparatus or a loudspeaker to emit a sound and light prompting message to the user.

It can be seen that in the embodiment of the disclosure, the controller 150 may generate the estimated time corresponding to the target temperature according to the temperature record information, so as to determine whether to activate the temperature protection operation according to the estimated time. Based on this, for a usage scenario where the heat dissipation capacity of the projection apparatus 100 gradually decreases as the number of times of use increments, the projection apparatus 100 of the embodiment of the disclosure can timely execute the temperature protection operation.

In addition, in the embodiment of the disclosure, the controller 150 may also judge whether the heat dissipation capacity of the projection apparatus 100 is suddenly abnormal according to the temperature record information. Moreover, in the embodiment of the disclosure, the controller 150 may also judge whether the heat dissipation capacity of the projection apparatus 100 is insufficient during the turn-on process (that is, the process of lighting up the light source of the projection module 140) according to the temperature record information. Embodiments will be listed below for description.

FIG. 8 is a flowchart of an overheating protection method according to an embodiment of the disclosure. Please refer to FIG. 1 and FIG. 8. The manner of the embodiment is applicable to the projection apparatus 100 in the foregoing embodiment, and the detailed steps of the overheating protection method of the embodiment will be described below with various elements in the projection apparatus 100.

In Step S802, the controller 150 obtains the initial stable temperature corresponding to the initial accumulated usage time during the initial usage period by using the temperature sensor 110 in the projection apparatus 100. The operation of this step is similar to Step S210, which has been described in the foregoing embodiment and will not be repeated here. In short, the initial stable temperature corresponding to the initial accumulated usage time may be used to estimate the estimated time corresponding to the target temperature.

In Step S804, the controller 150 obtains the temperature rising curve during the turn-on process through the temperature sensor 110. Specifically, every time the projection apparatus 100 is turned on, the controller 150 may obtain the temperature rising curve of the turn-on process by using the temperature sensor 110. In the embodiment, the temperature rising curve established during each turn-on process may be used to judge whether the heat dissipation capacity of the projection apparatus 100 is normal, that is, whether the heat dissipation capacity of the projection apparatus 100 is normal is judged as soon as possible by using the temperature rising situation during the turn-on process.

In Step S806, the controller 150 calculates a total temperature change before a specific time according to the temperature rising curve. The specific time is a time point when the temperature sensed by the temperature sensor 110 continuously rises during the turn-on process. In some embodiments, the controller 150 may perform an integral operation on the temperature rising curve according to the specific time to obtain the total temperature change within a time interval from the turn-on time to the specific time.

In Step S808, the controller 150 judges whether the total temperature change is greater than a change threshold. If the judgement of Step S808 is yes, Step S820 is executed. That is, the controller 150 executes the temperature protection operation of the projection apparatus 100 in response to the total temperature change being greater than the change threshold. In some embodiments, the change threshold is obtained by performing an integral operation on a specific temperature change curve according to the specific time, and multiple tangent slopes corresponding to multiple reference temperature change curves at the specific time meet an increment condition.

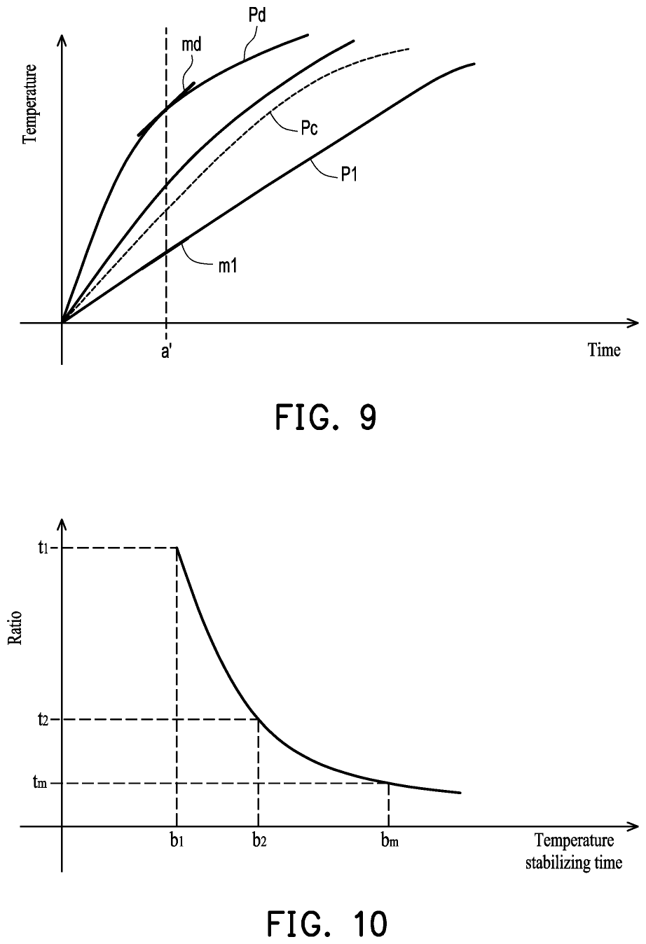

In detail, please refer to FIG. 9, which is a schematic diagram of temperature rising curves of multiple turn-on processes according to an embodiment of the disclosure. Through experiments, simulations, tests, etc., the temperature rising curves under different heat dissipation scenarios may be collected. In the embodiment of FIG. 9, a temperature rising curve Pa represents a temperature change under the worst heat dissipation situation. According to empirical rules and experiments, it can be seen that after the projection apparatus 100 is turned on, the temperature rising curve is a temperature rising curve Pc, which means that the projection apparatus 100 may be damaged before reaching the stable temperature. Therefore, the change threshold may be determined according to the temperature rising curve Pc.

In addition, the temperature sensor 110 inside the projection apparatus 100 needs a corresponding response time due to factors such as hardware actuation time or temperature diffusion. The response time is, for example, x seconds. Through taking the response time as the sampling unit time, the tangent slopes corresponding to different sampling time points of the temperature rising curves in FIG. 9 may be obtained. For example, for the temperature rising curve Pd, one tangent slope may be calculated every x seconds to obtain multiple tangent slopes corresponding to multiple different sampling time points. Based on the search condition that the worse the heat dissipation state, the greater the tangent slope, a specific time a′ may be obtained. In other words, at the specific time a′, the tangent slope from the temperature rising curve P₁ to the temperature rising curve P_{d} gradually increments. For example, at the specific time a′, a tangent slope md of the temperature rising curve P_{d} is greater than a tangent slope ml of the temperature rising curve P₁. Therefore, the specific time a′ may be used as a protection time point before the temperature of the projection apparatus 100 reaches the stable temperature after being turned on.

Therefore, the controller 150 may perform an integral operation on the temperature rising curve obtained after the current turn-on according to the specific time a′ to obtain the total temperature change within the time interval from the turn-on time to the specific time. If the total temperature change exceeds the sum of temperature changes of the temperature rising curve P_{c} before the specific time a′, it means that the heat dissipation capacity of the projection apparatus 100 is insufficient, so the corresponding temperature protection operation is activated. For example, the controller 150 may judge whether the total temperature change is greater than or equal to the change threshold according to the following formula.

$${\sum }_{j = 0}^{{a}^{′}} T ( j ) \geq {\int }_{0}^{{a}^{′}} {p}_{c} \qquad Formula ( 2 )$$

where Σⱼ₌₀^{a}′T(j) represents the total temperature change during the current turn-on process; and ∫₀^{a}′p_{c} represents the change threshold determined based on the temperature rising curve P_{c}. In this way, it can be seen that after the projection apparatus 100 is turned on, during the period from the turn-on time to the specific time a′, the controller 150 instantly sums up temperature values T(j) sensed by the temperature sensor 110 to obtain the total temperature change.

If the judgement of Step S808 is no, it means that the optical elements of the projection apparatus 100 will not be damaged before reaching the stable temperature. Next, in Step S810, the controller 150 obtains the at least one stable temperature respectively corresponding to the at least one accumulated usage time by using the temperature sensor 110 in the projection apparatus 100. In Step S812, the controller 150 estimates the estimated time corresponding to the target temperature according to the initial accumulated usage time, the initial stable temperature, the at least one stable temperature, and the at least one accumulated usage time. The operation content of Step S810 to Step S812 is similar to that of Step S220 and Step S230, and will not be repeated here.

In Step S814, during the running process of the projection apparatus 100, the controller 150 continuously senses multiple current temperatures by using the temperature sensor 110. Specifically, after the projection apparatus 100 reaches the stable temperature, the temperature sensor 110 still continuously senses the current temperatures, and reports the current temperatures to the controller 150.

In Step S816, during the running process of the projection apparatus 100, the controller 150 judges whether the current accumulated usage time of the projection apparatus 110 exceeds the estimated time. The operation content of Step S816 is similar to that of Step S240 and will not be repeated here.

It should be noted that if the judgement of Step S816 is no, in Step S818, the controller 150 judges whether a temperature rising value between the current temperatures and the previous stable temperature is continuously greater than a preset temperature difference parameter Ar for more than a specific observation time. The temperature rising value is a difference value respectively between the current temperatures and the previous stable temperature. When the temperature rising value between the current temperatures and the previous stable temperature is continuously greater than the preset temperature difference parameter Ar for more than the specific observation time, it means that the heat dissipation apparatus 120 of the projection apparatus 100 is abnormal. For example, the fan suddenly fails, the working temperature of the chip suddenly rises, the vent is blocked by a foreign object, etc., so the temperature protection operation of the projection apparatus 100 needs to be executed.

If the judgement of Step S818 is yes, Step S820 is executed. That is, the controller 150 executes the temperature protection operation of the projection apparatus 100 in response to the temperature rising value between the current temperatures and the previous stable temperature being continuously greater than the preset temperature difference parameter Ar for the specific observation time. In other words, the controller 150 executes the temperature protection operation of the projection apparatus 100 when the temperature rising value between the current temperatures and the previous stable temperature continuously reported by the temperature sensor 110 within the specific observation time is greater than the preset temperature difference parameter

Ar. Here, the preset temperature difference parameter Ar may be set according to actual requirements, experiments, and empirical rules.

It should be noted that the specific observation time may be determined according to the current stable temperature initially obtained at the current turn-on and the previous stable temperature obtained at the previous turn-on. In detail, in some embodiments, the at least one stable temperature respectively corresponding to the at least one accumulated usage time includes the previous stable temperature corresponding to the previous accumulated usage time and the current stable temperature corresponding to the current accumulated usage time. The controller 150 may calculate a time difference value between the previous accumulated usage time and the current accumulated usage time, and calculate a temperature difference value between the previous stable temperature and the current stable temperature. Then, the controller 150 may obtain a ratio according to the time difference value and the temperature difference value. Finally, the controller 150 may calculate the product of the ratio and the preset temperature difference parameter Ar to obtain the specific observation time.

Specifically, as mentioned above, the controller 150 may obtain the corresponding relationship between the stable temperatures temp(O₁), temp(O₂), . . . , temp(Oₘ) and the accumulated usage times q₁, q₂, . . . , qₘ. The controller 150 may calculate the time difference value between the previous accumulated usage time q₍ₘ₋₁₎ and the current accumulated usage time qₘ. In addition, the controller 150 may calculate the temperature difference value between the previous stable temperature temp(Oₘ₋₁) and the current stable temperature temp(Oₘ). Afterwards, through taking the time difference value as a numerator and the temperature difference value as a denominator, the controller 150 may obtain a ratio, which may be expressed as tₘ=(qₘ−q₍ₘ₋₁₎/(temp(oₘ)-temp(oₘ₋₁)). Therefore, through multiplying the ratio tₘ by the preset temperature difference parameter Ar, the controller 150 may obtain a specific observation time sₘ, that is, sₘ=tm*Δr.

In detail, please refer to FIG. 10, which is a schematic diagram of ratio against temperature stabilizing time according to an embodiment of the disclosure. Through long-term data collection, it can be found that with the increase of the accumulated usage time of the projection apparatus 100, the heat dissipation capacity of the projection apparatus 100 gradually decreases, so the ratios t₁, t₂, . . . , tₘ gradually decrements and the corresponding temperature stabilizing times b₁, b₂, . . . , bₘ become longer. The ratios t₁, t₂, . . . , tₘ may represent the time required for the stable temperature to generate a unit change. Therefore, the product of the ratio tₘ and the preset temperature difference parameter Δr (that is, the specific observation time sₘ) may be used as a criterion for judging whether the heat dissipation capacity of the projection apparatus 100 is abnormal. That is, if the current sensed temperature of the projection apparatus 100 is only temporarily greater than the previous stable temperature, the controller 150 may not activate the temperature protection operation. Conversely, if the current sensed temperature of the projection apparatus 100 is continuously greater than the previous stable temperature for the specific observation time sₘ, the controller 150 may activate the temperature protection operation to deal with the sudden abnormality in the heat dissipation capacity of the projection apparatus 100.

It should be noted that the processing procedure of the overheating protection method executed by the controller is not limited to the examples of the foregoing embodiments. For example, a part of the above steps may be omitted, and the steps may also be executed in other orders. Also, any two or more of the above steps may be combined, and a part of the steps may be modified or deleted. Alternatively, other steps in addition to the above steps may be executed.

In summary, in the projection apparatus and the overheating protection method of the embodiments of the disclosure, the heat dissipation capacity and the heat dissipation situation of the projection apparatus may be speculated according to the temperature record information of the temperature sensed by the temperature sensor to timely execute the temperature protection operation. Therefore, in the embodiments of the disclosure, the damage of the optical elements due to overheating can be prevented without disposing many temperature sensors and designing a special airtight structure for the temperature sensor.

In addition, in the projection apparatus and the overheating protection method of the embodiments of the disclosure, different abnormal heat dissipation scenarios may be monitored. The embodiments of the disclosure may monitor the abnormal heat dissipation scenario in which the heat dissipation capacity gradually decreases to not meet the requirements. In addition, the embodiments of the disclosure may monitor the abnormal heat dissipation scenario in which the heat dissipation capacity suddenly becomes abnormal. Moreover, the embodiments of the disclosure may monitor the abnormal heat dissipation scenario in which the accumulated heat energy is too high during the turn-on process. Therefore, the embodiments of the disclosure can effectively prevent the optical elements of the projection apparatus from being damaged due to overheating.

However, the above are only preferred embodiments of the disclosure, and the scope of implementation of the disclosure cannot be limited thereto, that is, all simple equivalent changes and modifications made according to the claims of the disclosure and the content of the description of the disclosure still belong to the scope covered by the disclosure. In addition, any embodiment or claim of the disclosure does not necessarily achieve all objectives, advantages, or features disclosed in the disclosure. In addition, the abstract and the title are only used to assist the search of patent documents and are not used to limit the scope of the claims of the disclosure.

What is claimed is:

1. An overheating protection method of a projection apparatus, comprising:
obtaining an initial stable temperature corresponding to an initial accumulated usage time during an initial usage period by using a temperature sensor in the projection apparatus;
obtaining at least one stable temperature respectively corresponding to at least one accumulated usage time by using the temperature sensor in the projection apparatus;
estimating an estimated time corresponding to a target temperature according to the initial accumulated usage time, the initial stable temperature, the at least one stable temperature, and the at least one accumulated usage time; and
executing a temperature protection operation of the projection apparatus in response to a current accumulated usage time of the projection apparatus exceeding the estimated time.

2. The overheating protection method of the projection apparatus according to claim 1, wherein the step of estimating the estimated time corresponding to the target temperature according to the initial accumulated usage time, the initial stable temperature, the at least one stable temperature, and the at least one accumulated usage time comprises:
establishing an interpolation polynomial by using the initial accumulated usage time, the initial stable temperature, the at least one stable temperature, and the at least one accumulated usage time; and
substituting the target temperature into the interpolation polynomial to obtain the estimated time.

3. The overheating protection method of the projection apparatus according to claim 1, wherein the step of obtaining the initial stable temperature corresponding to the initial accumulated usage time during the initial usage period by using the temperature sensor in the projection apparatus comprises:
collecting a plurality of temperature rising curves of a plurality of turn-on processes during the initial usage period by using the temperature sensor;
analyzing the temperature rising curves to determine the initial stable temperature; and
obtaining the initial accumulated usage time during the initial usage period.

4. The overheating protection method of the projection apparatus according to claim 3, wherein the step of analyzing the temperature rising curves to determine the initial stable temperature comprises:
obtaining a reference stable temperature of each of the temperature rising curves; and
performing a statistical analysis on the reference stable temperature of each of the temperature rising curves to determine the initial stable temperature.

5. The overheating protection method of the projection apparatus according to claim 1, wherein the at least one stable temperature respectively corresponding to the at least one accumulated usage time comprises a previous stable temperature corresponding to a previous accumulated usage time, the overheating protection method further comprising:
continuously sensing a plurality of current temperatures by using the temperature sensor; and
executing the temperature protection operation of the projection apparatus in response to a temperature rising value between the current temperatures and the previous stable temperature being continuously greater than a preset temperature difference parameter for more than a specific observation time.

6. The overheating protection method of the projection apparatus according to claim 5, wherein the at least one stable temperature respectively corresponding to the at least one accumulated usage time further comprises a current stable temperature corresponding to a current accumulated usage time, the overheating protection method further comprising:
calculating a time difference value between the previous accumulated usage time and the current accumulated usage time, and calculating a temperature difference value between the previous stable temperature and the current stable temperature;
obtaining a ratio according to the time difference value and the temperature difference value; and
calculating a product of the ratio and the preset temperature difference parameter to obtain the specific observation time.

7. The overheating protection method of the projection apparatus according to claim 1, further comprising:
obtaining a temperature rising curve of a turn-on process through the temperature sensor; and
calculating a total temperature change before a specific time according to the temperature rising curve; and
executing the temperature protection operation of the projection apparatus in response to the total temperature change being greater than a change threshold.

8. The overheating protection method of the projection apparatus according to claim 7, wherein the step of calculating the total temperature change before the specific time according to the temperature rising curve comprises:
performing an integral operation on the temperature rising curve according to the specific time to obtain the total temperature change within a time interval from a turn-on time to the specific time,
wherein the change threshold is obtained by performing an integral operation on a specific temperature change curve according to the specific time.

9. The overheating protection method of the projection apparatus according to claim 7, wherein a plurality of tangent slopes corresponding to the specific time on a plurality of reference temperature change curves meet an increment condition.

10. The overheating protection method of the projection apparatus according to claim 1, wherein the temperature protection operation comprises increasing a heat dissipation capacity of a heat dissipation apparatus or providing a warning message.

11. A projection apparatus, comprising:
a temperature sensor; and
a controller, coupled to the temperature sensor and configured to:
obtain an initial stable temperature corresponding to an initial accumulated usage time during an initial usage period by using the temperature sensor;
obtain at least one stable temperature respectively corresponding to at least one accumulated usage time by using the temperature sensor;
estimate an estimated time corresponding to a target temperature according to the initial accumulated usage time, the initial stable temperature, the at least one stable temperature, and the at least one accumulated usage time; and
execute a temperature protection operation of the projection apparatus in response to a current accumulated usage time of the projection apparatus exceeding the estimated time.

12. The projection apparatus according to claim 11, wherein the controller is further configured to:
establish an interpolation polynomial by using the initial accumulated usage time, the initial stable temperature, the at least one stable temperature, and the at least one accumulated usage time; and
substitute the target temperature into the interpolation polynomial to obtain the estimated time.

13. The projection apparatus according to claim 11, wherein the controller is further configured to:
collect a plurality of temperature rising curves of a plurality of turn-on processes during the initial usage period by using the temperature sensor;
analyze the temperature rising curves to determine the initial stable temperature; and
obtain the initial accumulated usage time during the initial usage period.

14. The projection apparatus according to claim 13, wherein the controller is further configured to:
obtain a reference stable temperature of each of the temperature rising curves; and
perform a statistical analysis on the reference stable temperature of each of the temperature rising curves to determine the initial stable temperature.

15. The projection apparatus according to claim 11, wherein the at least one stable temperature respectively corresponding to the at least one accumulated usage time comprises a previous stable temperature corresponding to a previous accumulated usage time, and the controller is further configured to:
continuously sense a plurality of current temperatures by using the temperature sensor; and
execute the temperature protection operation of the projection apparatus in response to a temperature rising value between the current temperatures and the previous stable temperature being continuously greater than a preset temperature difference parameter for more than a specific observation time.

16. The projection apparatus according to claim 15, wherein the at least one stable temperature respectively corresponding to the at least one accumulated usage time further comprises a current stable temperature corresponding to a current accumulated usage time, and the controller is further configured to:
calculate a time difference value between the previous accumulated usage time and the current accumulated usage time, and calculate a temperature difference value between the previous stable temperature and the current stable temperature;
obtain a ratio according to the time difference value and the temperature difference value; and
calculate a product of the ratio and the preset temperature difference parameter to obtain the specific observation time.

17. The projection apparatus according to claim 11, wherein the controller is further configured to:
obtain a temperature rising curve of a turn-on process through the temperature sensor; and
calculate a total temperature change before a specific time according to the temperature rising curve; and
execute the temperature protection operation of the projection apparatus in response to the total temperature change being greater than a change threshold.

18. The projection apparatus according to claim 17, wherein the controller is further configured to:
perform an integral operation on the temperature rising curve according to the specific time to obtain the total temperature change within a time interval from a turn-on time to the specific time,
wherein the change threshold is obtained by performing an integral operation on a specific temperature change curve according to the specific time.

19. The projection apparatus according to claim 17, wherein a plurality of tangent slopes corresponding to the specific time on a plurality of reference temperature change curves meet an increment condition.

20. The projection apparatus according to claim 11, further comprising a heat dissipation apparatus or a prompting apparatus, wherein the temperature protection operation comprises increasing a heat dissipation capacity of the heat dissipation apparatus or providing a warning message through the prompting apparatus.
